(19) United States
(12) Patent Application Publication
(10) Pub. No.: US 2015/0325052 A1
(43) Pub. Date: Nov. 12, 2015

(54) IMAGE SUPERPOSITION OF VIRTUAL OBJECTS IN A CAMERA IMAGE

(71) Applicant: AUDI AG, Ingolstadt (DE)

(72) Inventor: Marcus KUEHNE, Beilngries (DE)

(73) Assignee: AUDI AG, Ingolstadt (DE)

(21) Appl. No.: 14/707,349

(22) Filed: May 8, 2015

(30) Foreign Application Priority Data
May 8, 2014 (DE) 10 2014 006 732.7

(51) Int. Cl. G06T 19/00

(52) U.S. Cl. CPC G06T 19/006

(57) ABSTRACT

A method superposes a virtual graphical object on a camera image of a real item. The camera image is displayed by a display device. The method takes into consideration when superposing virtual graphical objects also the real items imaged in the camera image. To this end, a distance of the item from the display device is captured by a capturing device. By way of object data, a virtual object distance of the object from the display device is given. The object is only superposed on the camera image if the object distance is less than the captured distance of the item.

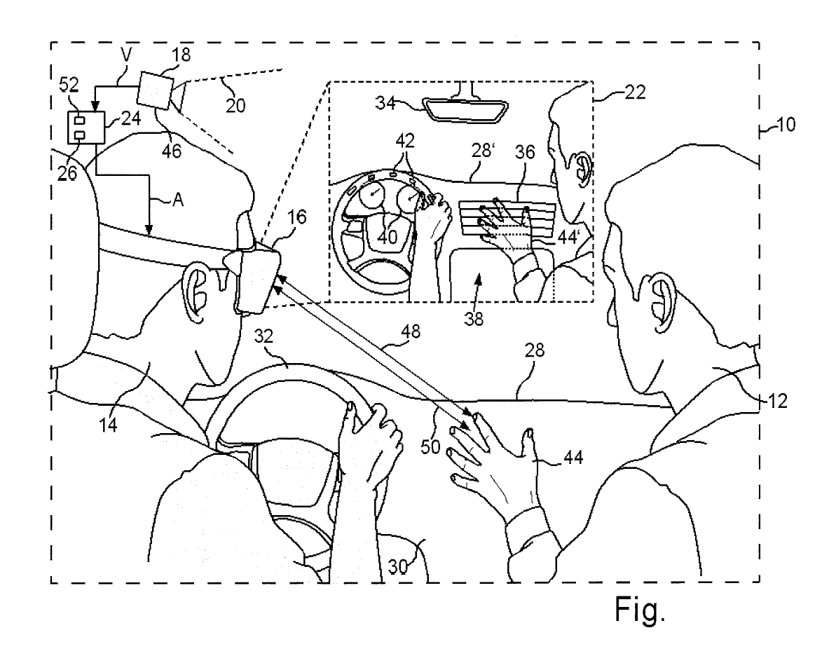

### CROSS REFERENCE TO RELATED APPLICATIONS

This application is based on and hereby claims priority to German Application No. 10 2014 006 732.7 filed on May 8, 2014, the contents of which are hereby incorporated by reference.

### BACKGROUND

The invention relates to a method for superposing a virtual graphical object on a camera image of a real item.

For the purpose of superposition, digital object data describing the object are inserted into the camera image, and the camera image thus prepared is displayed by a display device. This technology is also referred to as augmented reality or mixed reality.

In such mixed/augmented reality systems, the camera images are generally displayed to the user by using data glasses, and in the process the virtual graphical objects, that is to say virtual items, for example, are displayed in the real environment. What is difficult here is that in this form of representation, for example other real people that are visible in the camera image, can be seen in the space in addition to the virtual items, but these people are superposed by the represented virtual item, even if they are for example located closer to the user of the data glasses than the virtual item itself should be positioned. This significantly disrupts the illusion.

US 2012/0026191 A1 discloses a method in this respect, in which face detection is used to detect, in a camera image, a face of a person situated opposite the user, which face is filmed by a camera. Free image areas are then ascertained in the camera image on the basis of the face detection such that virtual objects, such as news text, can additionally be overlaid without overlap next to the face, and not in a disruptive manner in the face.

US 2012/0293548 A1 discloses a method for representing a live scene, such as a soccer match or an opera event, with which such image areas are automatically ascertained in a camera image in which an action that is of interest to the observer is taking place. Additional information relating to the action is then overlaid in the remaining regions of the camera image. The camera image thus prepared is presented to the user via data glasses.

DE 101 06 072 A1 describes data glasses having a projection lens, which represents laterally in the field of vision visual information, such as stock exchange news or appointment reminders, which the user can then see in front of the background, i.e. the real environment.

The known methods have the disadvantage that the user will always receive the additionally overlaid information, that is to say the virtual graphical objects, as unreal visual impressions which are superposed on the camera image of the real items, but not as objects which are integrated into the environment.

### SUMMARY

One possible object takes into consideration the real items imaged in the camera image when superposing or overlaying virtual graphical objects.

The inventor proposes a method for overlaying or superposing a virtual graphical object on a camera image of a real item solves the problem by establishing a spatial relationship between the object and the item. To this end, first the camera image is displayed by a display device in the known manner, and, in each case for superposing the object which is described by digital object data, at least part of the object data is inserted into the camera image. The insertion can be carried out by substituting camera image data or by combining camera image data with the object data for example using alpha blending.

According to the proposals, a distance of the item from the display device is captured by a capturing device. Said object data correspondingly comprise additionally a virtual object distance of the object from the display device. It is then checked whether the object distance is less than the captured distance of the real item, and only in that case is the object superposed on the camera image. If not, the object is not displayed, such that the resulting impression, as if the real item is obscuring the virtual object, forms. The distance can be, for example, a point which is closest to the display device or a geometric centroid. It is not necessary either for the distance itself to be specified. It is also possible for an absolute spatial position of the object to be specified by the object data, from which spatial position the distance can be derived.

The advantage resulting from the method is that the visual impression is given to an observer of the display device that the object is located as a further item together with the real item in the real environment that is represented by the camera image. The term camera image is understood to mean in particular an individual camera image or a video sequence.

The graphical object can be, in the manner described, for example a text and/or graphical notification, that is to say for example news or appointments, but also an item-like object, such as for example a motor vehicle or a component part of a motor vehicle.

The object can, however, be a component part of a larger virtual object, that is to say a partial region of the surface thereof. Correspondingly, one further development of the method makes provision for not only the distance to be ascertained, but also for a three-dimensional surface contour of the real item to be captured by the capturing device, that is to say the outer spatial form of the item. Accordingly, a three-dimensional object form of the object is described in the object data. Using an analysis device, for example a processor device of a control computer or a program module for a processor device, using a geometric section or a geometric superposition or penetration captured (real) surface contour with the (virtual) object form is carried out and thus ascertained, which part of the object protrudes from the surface contour. Protrudes in the present case is understood to mean that a check is carried out from the viewing angle of the display device as to which part of the object form is closer than the surface contour. Only the protruding part is then displayed by the display device. As a result, the impression of the presence of an actual object in the camera image is advantageously improved further.

The real item is preferably scanned optically or generally contactlessly, as a result of which it is possible to provide a particularly flexible augmented reality system. Preferably in the present case a 3D capturing device in the form of a time-of-flight camera is provided. Additionally or alternatively, the capturing device can also comprise a stereocamera and/or a laser scanner. The use of cameras has the particular advantage that they can also be used to produce the camera image itself.

With particular preference, the display device mentioned is integrated in data glasses, such that a user can carry the display device on his head in front of the eyes. What is particularly preferred here is that also a spatial position of the data glasses is ascertained, that is to say the alignment of the data glasses and thus of the head of the user thereof. A further improvement of the augmented reality effect results here if also a representation size and/or a perspective distortion of a displayed part of the virtual graphical object is set in dependence on the ascertained spatial position. By capturing the spatial position, this is possible by geometrical calculations which are known per se and easy to realize, for example on the basis of the principles of perspective representation according to a vanishing point perspective, an isometric representation or according to the centrally perspective representation.

According to one further development of the method, the object distance is set in dependence on the captured distance. In other words, there is a relationship between the captured distance of the real item and the object distance of the object. By way of example, moving the real item will also move the virtual object in the AR environment. For example, a user can thus pull the virtual object closer to him or push it away from him using his hand (real item). In the proposed method, this is made possible without complicated capturing of the hand's position, or generally the item's position, simply on the basis of the distance measurement.

The inventor also proposes a presentation apparatus, as can be used for example in what is known as a virtual showroom (presentation room). The presentation apparatus serves for representing at least one feature of a product. With respect to the at least one feature, respective object data for describing the feature as a virtual graphical object are stored in a memory of the presentation apparatus. If the product is, for example, a motor vehicle, special equipment of the motor vehicle can be provided as a feature, wherein the corresponding equipment item, for example a particular additional display, is then described as a virtual graphical object in the memory by object data. The presentation apparatus has a display device, in particular a display device that can be carried on the head, such as for example AR data glasses, and has the described capturing device and also a control device. The control device, for example a processor device, such as for example a computer, or a program module for such a processor device, is adapted to display on the display device a camera image, by way of which an item filmed by a camera is imaged, and to superpose on the camera image the at least one feature according to one embodiment of the method as a graphical object. By way of example, the filmed item can be a salesman, behind whom or around whom a particular vehicle model having the special features of custom equipment is displayed as an augmented-reality representation on the display device.

A particular advantage comes about in this instance if a mockup of basic equipment of the product is arranged in a capturing region of the camera. By way of example, it is possible therefore to provide a simple model of a motor vehicle in which a potential customer wearing data glasses in front of the eyes sits. Said control device is adapted in this case to superpose the at least one feature on the mockup imaged in the camera. For example, interior equipment features can be superposed as virtual graphical objects on the camera image of the basic equipment of the product, such that the user of the display apparatus has the visual impression that the mockup is equipped with said features. The use of the mockup here has the additional advantage that the user receives haptic feedback when touching the mockup, that is to say when he reaches for the product. For example, if basic equipment of a motor vehicle is provided, in the interior space of which particular operating elements are represented as virtual graphical objects, the user can for example press against a dash panel and obtain, using the display apparatus, an animation in the camera image of what would happen when actuating the operating apparatus, if the latter were in fact installed.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

The single FIGURE here shows a schematic illustration of an embodiment of the proposed presentation apparatus.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

The exemplary embodiment explained below is a preferred embodiment of the invention. However, in the exemplary embodiment, the described components of the embodiment in each case represent individual features of the invention, which should be considered independently of one another and which also independently of one another develop the invention further and should therefore also be regarded individually or in a combination other then the combination shown as a component part of the invention. Furthermore, the described embodiment can also be complemented by further ones of the already described features of the invention.

The FIGURE illustrates a presentation apparatus, or in other words a showroom 10. Located in the showroom 10 is a salesman 12 and a customer 14. The customer 14 looks at a display device 16, which may be for example data glasses which the customer 14 wears on his head in front of the eyes. A camera 18 films a region of the showroom 10, that is to say a capturing region 20 of the camera 18 is aimed into a region of the showroom 10. The camera image 22, that is to say a video sequence made up of a sequence of frames, is displayed to the customer 14 using the display device 16. The FIGURE illustrates the camera image 22 in the center of the image for clarity.

Video data V of the camera 18 are received and prepared by a control device 24. The prepared video data are output to the display device 16 as augmented-reality image data A for display.

In the camera image 22, additional object data can be added to the video data V, which object data can be stored in a memory 26 that is a component part of the control apparatus 24. With the object data, graphical objects are described which are represented or displayed in the image data 22 in addition to the images of real items from the showroom 10. By way of example, located in the capturing region 20 as real items can be a mockup 28 of a product that the salesman 12 wishes to sell, for example a motor vehicle, and also the salesman 12 and the customer 14. The mockup 28 can comprise for example a dash panel 30 and a steering wheel 32. In the case of the dash panel 30, provision may however be made for said dash panel not to have any operating elements. In the example, the salesman 12 explains to the customer 14 details regarding additional equipment features which the customer 14 may order in addition to the product. These additional features are graphically superposed as the virtual graphical objects in the camera image 22 on the image 28′ of the mockup 28. By way of example, additional equipment features which may be provided are a rear view mirror 34, a controllable blower outlet 36, an infotainment system 38, an instrument cluster 40 and operating and/or display elements 42 on the steering wheel 32.

In the camera image 22, these additional equipment features are not simply superposed as graphical objects on the camera image, but the customer 14 has the visual impression that these features are also arranged spatially correctly with respect to the real elements of the mockup 28.

In respect of the salesman 12, in the camera image 22, a hand 44 of the salesman 12 is also correctly represented in front of the vent outlet 36 and the infotainment system 38, that is to say the image 44′ of the real hand 44 covers parts of the vent outlet 36 and the infotainment system 38, which is also illustrated in the FIGURE by way of a dashed illustration of the covered portions. With respect to the remaining objects, covered portions of the graphical objects are also illustrated as dashed lines in the FIGURE.

In the mockup 28 of the vehicle, which is projected virtually into the space of the camera image 22, the customer 14 then sits on the seat in a sitting position in a virtual vehicle with another present person, that is to say the salesman 12 in the example, next to him. The salesman 12 can likewise view the camera image 22 with an additional screen (not shown), as it is displayed to the customer 14 using the display device 16. In this case, she may sit on a passenger seat of the mockup 28 for a sales pitch, for example. In a conventional augmented-reality system with data glasses, for the customer 14 however, the salesman 12 himself would then remain outside the vehicle even though she is situated inside a contour of the motor vehicle, that is to say her hand 44 is located between the dash panel 28 and the display device 16, for example. The reason for this is that traditional augmented-reality systems superpose in the camera image 22 only the virtual graphical objects.

By contrast, in the presentation apparatus 10, in each case part of the virtual graphical objects is covered by the image of the real hand 44. For this, a distance 48 between the real items is ascertained using a capturing device 46, which can be a component part of the camera 18, for example. To this end, the display device 16 is also located in the presentation apparatus 10 in a known manner. The FIGURE illustrates by way of example the distance 48 of the hand 44 from the display device 16. The capturing device 46 can be based, for example, on time-of-flight capturing, which can be achieved by the camera 18 being configured as a ToF camera. With respect to the individual features, that is to say the graphical objects, in each case a spatial position is stored in the object data in the memory 26 such that a distance 50 of a graphical object, illustrated in the example is the distance 50 of the vent outlet 36, from the display device 16 can be ascertained. A comparison of the distance 48 with the distance 50 shows that the hand 44 is closer to the display device 16 than the vent outlet 16. Accordingly, image points which belong to the image 44—of the hand 44 must be represented in the camera image 22 and the corresponding image points of the graphical object, by contrast, must not be represented.

Through the combination of the augmented-reality representation using the display device 16 with a capturing device 46, such as a 3D camera, such as for example a time-of-flight camera, it is thus possible to capture real items and persons located in the projection space and to include them in the computation of the augmented-reality representation. The camera 18 and the capturing device 46 can here be positioned in the data glasses, which simplifies a representation of the graphical objects that is faithful to the perspective, or can also be positioned at different places in the space of the projection apparatus 10. If the control device 24 here detects that a real body is present between a virtual partial element and the observer, the augmented-reality representation can be matched accordingly. Since the exact position and orientation of the glasses must be known for a spatial augmented-reality representation, it is possible in conjunction with the known position and the dimension of the real body to remove the augmented-reality representation accordingly from the region.

By locating the display device 16 it is also possible to compute and represent in the camera image 22, if the head of a customer 14 moves, a parallax of the imaged real items and the features. It is also possible, using a ToF camera, to check which parts of the features 34, 36, 38, 40, 42 are covered for example by the steering wheel or the hand 44, and to only not represent the parts that are in fact covered, and to represent the remaining parts as superposition on the video data V in the camera image 22. To this end, the control device 24 can have an analysis device 52, which can ascertain, on the basis of the 3D image data of a time-of-flight camera, surface contours of the mockup 28 and of the hand 44 and can check whether the object forms of the features 34, 36, 38, 40, 42 protrude from the surface contours in the viewing angle of the display device 16 or are covered thereby.

Overall, the example shows the realization of a correct representation of real persons and/or items in an augmented-reality environment.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide V. DIRECTV, 69 USPQ2d 1865 (Fed. Cir. 2004).

1. A method for superposing a virtual graphical object on a camera image of a real item, comprising:
describing the virtual graphical object by digital object data;
capturing a distance from the real item to a display device by a capturing device, the distance of the real item being captured to produce a captured distance;
defining by way of the object data, a virtual object distance from the virtual graphical object to the display device;
displaying the camera image by the display device; and
superposing the virtual graphical object on the camera image, so as to insert at least part of the virtual graphical object in the camera image, only if the virtual object distance is less than the captured distance.

2. The method according to claim 1, wherein
a three-dimensional surface contour of the real item is captured by the capturing device,
the virtual graphical object has a three-dimensional form,
the object data describes the three-dimensional form of the virtual graphical object,
it is ascertained using an analysis device by way of a geometric section of the surface contour with the three-dimensional form, which part of the virtual graphical object protrudes from the surface contour, and
only the part which protrudes is displayed by the display device.

3. The method according to claim 1, wherein
a three-dimensional surface contour of the real item is captured by the capturing device,
the virtual graphical object has a three-dimensional form,
the object data describes the three-dimensional form of the virtual graphical object,
the surface contour of the real item is compared with the three-dimensional form of the virtual graphical object to identify a protruding part of the virtual graphical object which protrudes from the surface contour of the real item, and
only the protruding part is displayed by the display device.

4. The method according to claim 1, wherein the capturing device is a device selected from the group consisting of a time-of-flight camera, a stereocamera and a laser scanner.

5. The method according to claim 1, wherein
the display device is integrated in data glasses,
a spatial position of the data glasses is ascertained, and
in the object data, a representation size and/or a perspective distortion of the virtual graphical object is set in dependence on the spatial position.

6. The method according to claim 1, wherein the virtual object distance is defined in dependence on the captured distance.

7. The method according to claim 1, wherein
defining the virtual object distance comprises setting the virtual object distance to be less than the captured distance.

8. The method according to claim 1, wherein
the camera image comprises an image of first and second real items,
the virtual object distance of the virtual graphical object is set to correspond with, and be less than, the captured distance of the first real item,
the second real item has a position and captured distance that varies independently of the position and virtual object distance of the virtual graphical object, and
to the extent that the second real item is positioned between the virtual graphical object and the capturing device, the virtual graphical object is not displayed.

9. The method according to claim 1, wherein the capturing device captures the distance of the real item from eyes of a viewing user.

10. The method according to claim 1, wherein
the object data specifies an absolute spatial position of the virtual graphical object, and
the virtual object distance is derived from the absolute spatial position so as to be less than the captured distance.

11. The method according to claim 1, wherein the virtual graphical object comprises a text or graphical notification.

12. A presentation apparatus to present a feature of a product, comprising:
a memory to store digital object data that describes the feature using a virtual graphical object;
a display device;
a capturing device to capture as a captured distance, a distance from a real item to the display device; and
a control device to define by way of the object data, a virtual object distance from the virtual graphical object to the display device, to display on the display device a camera image of the real item, and to superpose the virtual graphical object on the camera image, so as to insert at least a part of the virtual graphical object in the camera image, only if the virtual object distance is less than the captured distance.

13. The presentation apparatus according to claim 12, wherein
the real item comprises a mockup of basic equipment of the product,
the mockup is arranged in a capturing region so as to be included in the camera image, and
the control device displays on the display device, the virtual graphical object superposed on the mockup.

14. The presentation apparatus according to claim 12, wherein the display device, the capturing device and a camera to obtain the camera image are integrated into data glasses worn by a viewing user.

15. The presentation apparatus according to claim 12, wherein
the real item comprises a hand of a viewing user,
the virtual graphical object comprises a movable device, and
the virtual object distance is set to be less than the captured distance so the hand of the viewing user virtually moves the virtual graphical object.

16. The presentation apparatus according to claim 12, wherein
the real item comprises a hand of a viewing user, and
the virtual graphical object is animated based on changes in a position of the hand of the viewing user.

17. The presentation apparatus according to claim 12, wherein
the mockup comprises a dash panel without operating elements, and
the virtual graphical object comprises at least one of a controllable blower outlet, an infotainment system, an instrument cluster, operating elements on a steering wheel and display elements on the steering wheel.
